(19) United States
(12) Patent Application Publication
(10) Pub. No.: US 2008/0284377 A1
(43) Pub. Date: Nov. 20, 2008

(54) BATTERY CHARGING APPARATUS

(75) Inventors: YING CHEN, Shenzhen (CN); JIN-LIANG XIONG, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD, Shenzhen City (TW); HON HAI PRECISION INDUSTRY CO., LTD., Taiperi Hsien (TW)

(21) Appl. No.: 11/930,173

(22) Filed: Oct. 31, 2007

(30) Foreign Application Priority Data
May 18, 2007 (CN) 200710200644.5

(51) Int. Cl. H02J 7/00

(52) U.S. Cl. 320/137

(57) ABSTRACT

An exemplary battery charging apparatus for charging a storage battery includes a power input configured for receiving power from a voltage source, a zener diode, a voltage divider, a driving circuit, a switching circuit, and a power output. The cathode of the zener diode is connected to the power input, the anode of the zener diode is connected to ground via the voltage divider. The driving circuit has an input connected to an output of the voltage divider, an output connected to a first terminal of the switching circuit, a second terminal of the switching circuit is connected to the power input, a third terminal of the switching circuit is connected to the power output which is connected to the storage battery. The battery charging apparatus can protect the storage battery from being charged by over voltage.

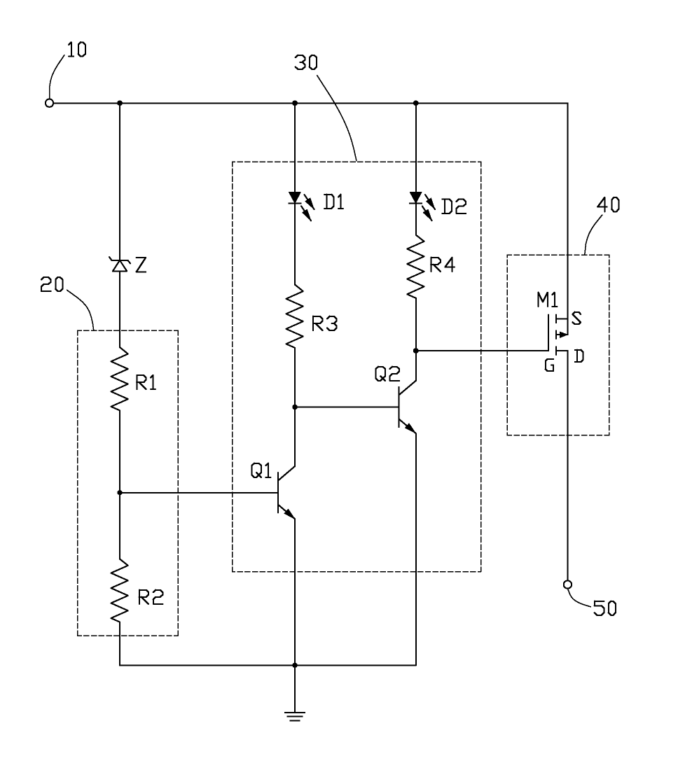

### BACKGROUND

1. Field of the Invention

The present invention relates to battery charging apparatuses, and particularly to a battery charging apparatus having a protection function that cuts off the current path when a charge abnormality occurs.

2. Description of Related Art

Storage batteries are often used for providing power in various pieces of equipment. If a battery charging apparatus for charging the storage batteries has no protection function, during charging the storage batteries, a charge abnormality may take place. There are various types of charge abnormalities, such as over charging voltage provided to the battery, reverse charging polarity of a battery charging apparatus, etc. When such an abnormality takes place, it is necessary to detect it appropriately and to protect the battery and the external equipment from damage.

What is needed, therefore, is a battery charging apparatus having a protection function that cuts off the current path when a charge abnormality occurs.

### SUMMARY

An exemplary battery charging apparatus for charging a storage battery includes a power input configured for receiving power from a voltage source, a zener diode, a voltage divider, a driving circuit, a switching circuit, and a power output. The cathode of the zener diode is connected to the power input, the anode of the zener diode is connected to ground via the voltage divider. The driving circuit has an input connected to an output of the voltage divider, an output connected to a first terminal of the switching circuit, a second terminal of the switching circuit is connected to the power input, a third terminal of the switching circuit is connected to the power output which is connected to the storage battery. When voltage at the power input is greater than the breakdown voltage of the zener diode, the driving circuit outputs a control signal to turn off the switching circuit to cut off a current path from the power input to the power output thereby protecting the storage battery from over voltage charging.

Other advantages and novel features will become more apparent from the following detailed description when taken in conjunction with the accompanying drawing, in which:

### BRIEF DESCRIPTION OF THE DRAWINGS

The drawing is a circuit diagram of a battery charging apparatus having a protection function in accordance with an embodiment of the present invention.

### DETAILED DESCRIPTION

Referring to the drawing, a battery charging apparatus having a protection function in accordance with an embodiment of the present invention includes a power input 10, a zener diode Z, a voltage divider 20, a driving circuit 30, a switching circuit 40, and a power output 50. The battery charging apparatus has a two-prong wall plug for plugging into an AC outlet, and transforming power therefrom to an input voltage received by the power input 10, and a battery to be charged is connected to the power output 50.

The power input 10 is connected to the cathode of the zener diode Z, the anode of the zener diode Z is connected to ground via the voltage divider 20. The driving circuit 30 includes an input and an output, the switching circuit 40 includes a first terminal, a second terminal, and a third terminal. An output of the voltage divider 20 is connected to the input of the driving circuit 30. The output of the driving circuit 30 is connected to the first terminal of the switching circuit 40, the power input 10 of the battery charging apparatus is connected to the second terminal of the switching circuit 40, and the third terminal of the switching circuit 40 is connected to the output 50 of the battery charging apparatus.

The voltage divider 20 includes resistors R1 and R2 connected in series. The anode of the zener diode Z is connected to ground via the resistors R1 and R2, and a node between the resistors R1 and R2 acts as the output of the voltage divider 20.

The driving circuit 30 includes NPN transistors Q1 and Q2, resistors R3 and R4, and diodes D1 and D2. The diodes D1 and D2 are light emitting diodes, and have different colors. In this embodiment, the diode D1 emits red light, and the diode D2 emits green light. The base of the transistor Q1 acting as the input of the driving circuit 30, is connected to the output of the voltage divider 20, the emitter of the transistor Q1 is grounded, and the collector of the transistor Q1 is connected to an end of the resistor R3. The other end of the resistor R3 is connected to the cathode of the diode D1, the anode of the diode D1 is connected to the power input 10 of the battery charging apparatus. The base of the transistor Q2 is connected to the collector of the transistor Q1, the emitter of the transistor Q2 is grounded, the collector of the transistor Q2 is connected to an end of the resistor R4, the other end of the resistor R4 is connected to the cathode of the diode D2, and the anode of the diode D2 is connected to the power input 10 of the battery charging apparatus. The collector of the transistor Q2 acts as the output of the driving circuit 30.

The switching circuit 40 includes a PMOS transistor M1, the gate of the PMOS transistor M1 acting as the first terminal of the switching circuit 40, is connected to the output of the driving circuit 30, the source of the PMOS transistor M1 acting as the second terminal of the switching circuit 40, is connected to the power input 10 of the battery charging apparatus, the drain of the PMOS transistor M1 acting as the third terminal of the switching circuit 40, is connected to the power output 50 of the battery charging apparatus.

When the two-prong wall plug of the battery charging apparatus is connected to the outlet normally, a positive voltage is obtained at the power input 10 of the battery charging apparatus by transforming, rectifying, and filtering the AC signal. If the positive voltage at the input 10 is lower than the zener voltage, current cannot pass through the zener diode Z, and the transistor Q1 is off due to a low level voltage at the base of the transistor Q1. A voltage at the collector of the transistor Q1 is at a high level, and the diode D1 is off. A voltage at the base of the transistor Q2 is at a high level, the transistor Q2 is turned on, the diode D2 is turned on and emits green light to indicate normal charging. The PMOS transistor M1 is turned on, the power output 50 outputs the voltage from the power input 10 to charge the battery.

When voltage at the power input 10 is greater than the zener voltage, which means over voltage, current will pass through the zener diode Z, the voltage at the base of the transistor Q1 goes high, the transistor Q1 is turned on, and the voltage at the collector of the transistor Q1 goes low, the diode D1 is turned on and emits red light to indicate abnormal charging. The transistor Q2 is turned off, the diode D2 is turned off and does not emit light. The PMOS transistor M1 is turned off, so the current path from the power input 10 to the power output 50 is cut off, the battery charging apparatus stops charging the battery to protect the battery from over-voltage.

When the two-prong wall plug of the battery charging apparatus is connected to the outlet backwards, the voltage at the power input 10 is negative, the transistors Q1 and Q2 are off, the diodes D1 and D2 are off and emit no light, and the PMOS transistor M1 is off, so there is no current flow from the power input 10 to the power output 50 of the battery charging apparatus, the battery charging apparatus cannot charge the battery, thus protecting the battery from damage due to reverse charging polarity of the battery charging apparatus.

The foregoing description of the exemplary embodiment of the invention has been presented only for the purposes of illustration and description and is not intended to be exhaustive or to limit the invention to the precise forms disclosed. Many modifications and variations are possible in light of the above teaching. The embodiment was chosen and described in order to explain the principles of the invention and its practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiment described therein.

What is claimed is:

1. A battery charging apparatus for charging a storage battery, comprising:
a power input configured for receiving power from a voltage source;
a zener diode, the cathode of the zener diode connected to the power input;
a voltage divider having an output, the anode of the zener diode connected to ground via the voltage divider;
a driving circuit having an input connected to the output of the voltage divider, and an output;
a switching circuit having a first terminal connected to the output of the driving circuit, a second terminal connected to the power input, and a third terminal; and
a power output configured for connecting to the storage battery, the power output connected to the third terminal of the switching circuit, wherein when a voltage at the power input is greater than the breakdown voltage of the zener diode, the driving circuit outputs a control signal to the first terminal of the switching circuit to turn off the switching circuit to cut off a current path from the power input to the power output, thereby protecting the storage battery from being charged by over voltage.

2. The battery charging apparatus as claimed in claim 1, wherein the voltage divider comprises two resistors connected in series, a node between the two resistors acts as the output of the voltage divider.

3. The battery charging apparatus as claimed in claim 1, wherein the switching circuit comprises a PMOS transistor, the gate, drain, and source of the PMOS transistor act as the first terminal, second terminal, and third terminal of the switching circuit, respectively.

4. The battery charging apparatus as claimed in claim 1, wherein the driving circuit comprises a first NPN transistor, a second NPN transistor, a first resistor, and a second resistor, the base of the first NPN transistor acts as the input of the driving circuit, the emitters of the first and second NPN transistors are grounded, the collectors of the first and second NPN transistors are connected to the power input via the first resistor and the second resistor, respectively, and the collector of the second NPN transistor acts as the output of the driving circuit.

5. The battery charging apparatus as claimed in claim 4, wherein the driving circuit further comprises a first diode and a second diode, the anodes of the first and second diodes are connected to the power input, the cathodes of the first and second diodes are connected to the collectors of the first NPN transistor and the second NPN transistor, respectively.

6. The battery charging apparatus as claimed in claim 5, the first and second diodes emit different color light, when the voltage at the power input is greater than the breakdown voltage of the zener diode, the first diode emits light.

7. A battery charging apparatus comprising:
a power input configured for receiving power from a voltage source;
a zener diode, the cathode of the zener diode connected to the power input;
a voltage divider having an output, the anode of the zener diode connected to ground via the voltage divider;
a driving circuit having an input connected to the output of the voltage divider, and an output;
a switching circuit having a first terminal connected to the output of the driving circuit, a second terminal connected to the power input, and a third terminal; and
a power output configured for connecting to a battery to be charged, the power output connected to the third terminal of the switching circuit, the driving circuit configured to output a control signal to turn on or off the switching circuit to thereby enable or disenable charging the battery, and when a voltage at the power input is negative, the driving circuit is not activated thereby protecting the battery.

8. The battery charging apparatus as claimed in claim 7, wherein the driving circuit comprises a first NPN transistor, a second NPN transistor, a first resistor, and a second resistor, the base of the first NPN transistor acts as the input of the driving circuit, the emitters of the first and second NPN transistors are grounded, the collectors of the first and second NPN transistors are connected to the power input via the first resistor and the second resistor, respectively, and the collector of the second NPN transistor acts as the output of the driving circuit.

9. The battery charging apparatus as claimed in claim 7, wherein the switching circuit comprises a PMOS transistor, the gate, drain, and source of the PMOS transistor act as the first terminal, second terminal, and third terminal of the switching circuit, respectively.

10. A battery charging apparatus comprising:
a power input configured for receiving power from a voltage source;
a power output configured for connecting to a battery to be charged;
a switching circuit connected between the power input and the power output, the switching circuit comprising a control terminal;
a driving circuit configured to output a control signal to turn on or off the switching circuit to thereby enable or disenable charging the battery, the driving circuit comprising an output connected to the control terminal of the switching circuit, and an input; and
a zener diode, the cathode of the zener diode connected to the power input, the anode of the zener diode connected to the input of the driving circuit; wherein
when a voltage at the power input is greater than the breakdown voltage of the zener diode, the driving circuit outputs the control signal to turn off the switching circuit to thereby cut off a current path from the power input to the power output; and
when a voltage at the power input is negative, the driving circuit is not activated and the switching circuit is turned off.

11. The battery charging apparatus as claimed in claim 10, further comprising a voltage divider having an output connected to the input of the driving circuit, the anode of the zener diode connected to ground via the voltage divider.

12. The battery charging apparatus as claimed in claim 10, wherein the driving circuit comprises a first diode and a second diode respectively configured to indicate the storage battery being normal charged and charged by over voltage.

13. The battery charging apparatus as claimed in claim 12, wherein the driving circuit comprises a first NPN transistor, a second NPN transistor, a first resistor, and a second resistor, the base of the first NPN transistor acts as the input of the driving circuit, the emitters of the first and second NPN transistors are grounded, the collectors of the first and second NPN transistors are connected to the power input via the first resistor and first diode, and the second resistor and second diode, respectively, the and the collector of the second NPN transistor acts as the output of the driving circuit.
